(19) United States
(12) Patent Application Publication
(10) Pub. No.: US 2007/0175771 A1
(43) Pub. Date: Aug. 2, 2007

(54) Container for preparing mixtures

(76) Inventor: Steven M. Hooser, Geneva, IL (US)

Correspondence Address: OLSON & HIERL, LTD., 20 NORTH WACKER DRIVE, 36TH FLOOR, CHICAGO, IL, 60606, US

(21) Appl. No.: 11/345,744

(22) Filed: Feb. 2, 2006

(51) Int. Cl. B65D 85/00; B65D 77/00; B65D 25/08; B01D 24/38

(52) U.S. Cl. 206/.5; 206/219; 206/217; 210/464

(57) ABSTRACT

A preparation system includes a cup or other vessel within which is fitted a liner. The liner and cup are spaced from one another and at least the upper portion of the liner is sealed to the cup to form an enclosed cavity within which a preparation component may be dispensed. The liner is foraminous, formed either of perforated material or material which is inherently foraminous. Upon introduction of a liquid or other substance into the liner, the substance contacts the dispensed material to form a desired composition. The preparation system may be provided as separate components to a food or drug manufacturer, for example, who dispenses into the cavity one or more components to be stored therein upon fitting the liner to the cup.

### FIELD OF THE INVENTION

The present invention relates to unitary container assemblies suitable for preparing non-food mixtures as well as food items such as coffee or tea, and in particular to such containers which are disposable after use.

### BACKGROUND OF THE INVENTION

Traditional methods for preparing beverages and other food items such as coffee, tea, soup broths or the like typically require multiple vessels for containing the beverage components, another vessel for cooking, brewing, or otherwise preparing the food item and perhaps yet another vessel for serving the food item. However, these traditional methods are unsuitable for automated vending or for instant preparations by the consumer. It has been found generally desirable for such systems, that the number of containers and other utensils be minimized.

Some arrangements, such as those frequently used in hotels and other rental accommodations have been proposed, using a combination of reusable vessels and utensils along with one or more disposable components. For example, ground coffee beans are prepared and prepackaged in a water permeable bag which allows heated water to pass through so as to brew the coffee beans. Once the coffee is brewed, the package of coffee beans is discarded.

U.S. Pat. No. 4,027,582 shows a drip coffee maker employing reusable components, which is suitable for preparing a small number of servings. Further advances in the art of disposable beverage preparations is shown in U.S. Pat. No. 4,134,492 which shows a single-use cup provided with a sealed compartment that holds a beverage concentrate isolated by a removable film. For use, the film is removed and the cup is filled with water that dissolves the concentrate. After a suitable time to allow dissolution, the contents, of the cup is ready for consumption by a user. Upon consumption of the beverage the cup is then discarded.

U.S. Pat. No. 5,605,710 shows a combination of reusable and disposable components, wherein a single cup disposable coffee brewing device is provided with a filter which contains pre-ground coffee beans. The filter is disposed over a reusable vessel such as a coffee mug and externally prepared heated water is poured over the filter and its contents, with the resulting brewed coffee draining into the coffee mug.

A need also exists for improved packaging of analytical and therapeutic products. Easy to use, premeasured kits in particular, are in demand.

### SUMMARY OF THE INVENTION

The present invention provides a novel and improved preparation system for food and non-food items. A cup is provided for holding a first component such as hot water and defining a cavity for holding a food item or a chemical reagent as a second component. The cup has a side wall with an inner surface. A liner having a liner side wall is disposed within the cup and is secured to the inner surface. At least a portion of the liner side wall is spaced from the inner surface of the cup side wall to define a cavity for receiving at least one other component, such as ground coffee beans, a chemical reagent, and the like. At least a portion of the liner is foraminous so as to allow communication between the first and the at least one other component, while retaining at least a portion of the at least one other component in the cavity during preparation and use. In one embodiment, the cup and the liner are in sealing engagement with one another. The cup, the liner, or both can have either a frustoconical or a conical shape, or any other convenient shape, as may be desired. The liner can be rendered foraminous by perforation, by having a window covered with a foraminous covering, or by being made of a foraminous material in its entirety.

An assembly for beverage preparation can be provided with a film overwrapping. Preferably, a plurality of individual preparation systems is provided, each system being overwrapped with its own film portion. In one instance, the film overwrap conforms to the liner, so as to allow nesting with a second overwrapped preparation system. Thus, Volatile components stored within the system cavity can be maintained fresh, and ready for individual use without compromising other preparation systems.

A system for preparing a solution from multiple components comprises a foraminous liner disposed within a cup and defining a compartment that is in fluid flow communication with the cup. Side walls of the liner and cup are spaced from one another so as to form a compartment or cavity for receiving at least one second component. In one instance, the second component comprises a solute of solid or non-flowing material, such as a material having jelly-like consistency. When a first component such as a solvent is introduced into the cup, it communicates with the second component through the liner. The first component can be a solvent, reagent, or a sample to be analyzed in either liquid or gaseous state.

### BRIEF DESCRIPTION OF THE DRAWINGS

In the drawings,

FIG. 1 is a schematic cross-sectional view of a beverage preparation assembly illustrating the present invention;

FIG. 2 is a schematic top plan view of a blank used with the assembly of FIG. 1;

FIG. 3 is a schematic cross-sectional view of another embodiment of a beverage preparation system illustrating the present invention;

FIG. 4 is a schematic representation of a blank of an inner liner used with the assembly of FIG. 3;

FIG. 5 is a fragmentary schematic cross-sectional view of an inner liner illustrating the present invention; and

FIG. 6 is a fragmentary schematic cross-sectional view of another inner liner illustrating the present invention.

### DESCRIPTION OF THE PREFERRED EMBODIMENTS

The invention disclosed herein is, of course, susceptible of embodiment in many forms. Shown in the drawings and described herein below in detail are the preferred embodiments of the invention. It is to be understood, however, that the present disclosure is an exemplification of the principles of the invention and does not limit the invention to the illustrated embodiments.

For ease of description, preparation systems embodying the present invention are described herein below in their usual assembled positions as shown in the accompanying drawings and terms such as front, rear, upper, lower, top, bottom, inner, outer, horizontal, longitudinal, etc. may be used herein with reference to this usual position. However, the preparation systems may be manufactured, transported, sold, or used in orientations other than that described and shown herein. As another example, the present invention is described as pertaining to the preparation of “mixtures”. It should be understood however that the term “mixtures” applies to virtually any type of combination of ingredients, such as solutions, colloidal suspensions and combinations thereof.

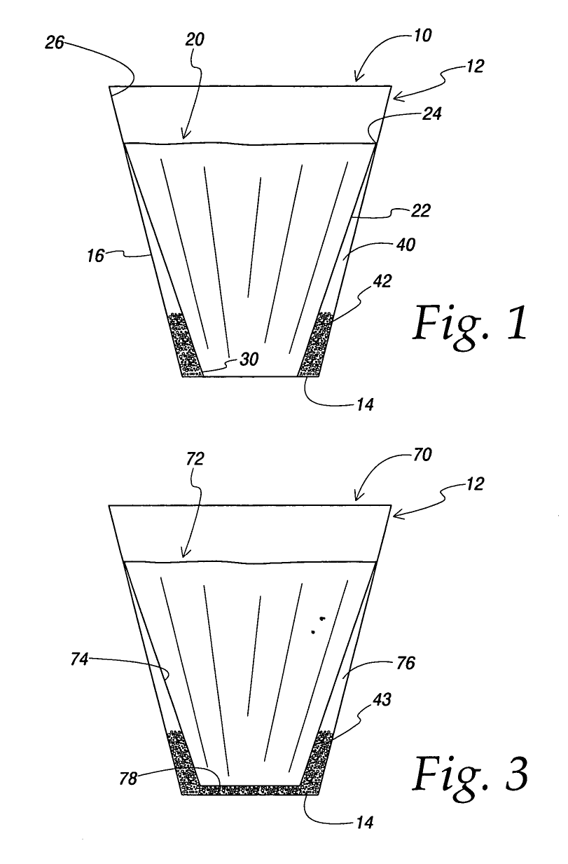

Referring now to the drawings, and initially to FIG. 1, a preparation system is generally indicated at 10. Included in system 10 is an outer vessel or cup 12 suitable for receiving and holding a quantity of liquid, a first component. Cup 12 is preferably made of a single layer of paper or paper product material and can be constructed according to known methods. In a preferred embodiment illustrated in FIG. 1, cup 12 has a flat bottom wall 14 and a frustoconical side wall 16. As illustrated in FIG. 1, bottom wall 14 is flush with the bottom of cup 12. If desired, side walls 16 can extend below bottom wall 14 to form a rim as is known.

Cup 12 can be made from virtually any compatible sheet material including paper, paper board, metallized products, coated paper and plastic, for example. Cup 12 can be made in virtually any manner known today. Cup 12 can be formed by molding any of a variety of known materials, such as paper, paper products, plastic and metallized materials, as well as layers of the same or a combination of different materials. The components of cup 12 may be joined by any conventional means such as adhesives or sonic welding, for example. As mentioned, it is generally preferred that cup 12 be formed from a single layer of paper or paper product material. However, cup 12 could also be formed from multiple layers of the same or different materials. For example, walls 16 can be formed as a composite layer of an inner liquid-retaining material and an outer material such as corrugated cardboard or foam which traps air to provide a thermal barrier and/or thermal insulation.

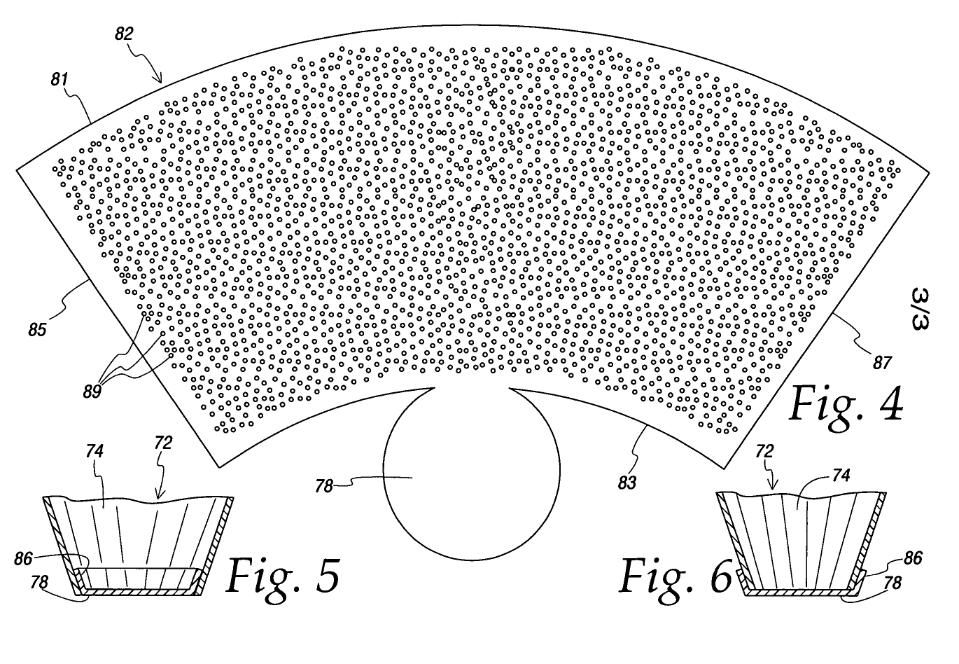

Disposed within cup 12 is a liner generally indicated at 20 and having a frustoconical side wall 22. The upper periphery of liner 20, indicated at 24 is preferablyjoined or otherwise sealed to the inner surface 26 of cup side wall 16. A bottom end portion 30 of liner side wall 22 is sealed to bottom wall 14 of cup 12. The bottom end portion 30 may be directly joined to bottom wall 14 by adhesives, sonic welding or the like, or bottom end portion 30 can be extended to form a transverse flap extending either radially inwardly or radially outwardly of frustoconical wall 22 so as to overlie a portion of bottom wall 14. Alternatively, the bottom end portion 30 of liner side wall 22 may be unitary with a perforated blank such as blank 82 shown in FIG. 4. The bottom wall of the liner can then be placed in contact with bottom wall 14 and joined thereto using conventional methods, or joined only to blank 82, and the liner mounted so as to provide a space between it and the bottom wall 14.

In addition to using adhesive and thermal welding joining processes, the liner can be effectively sealed to the cup with a mechanical system. For example, a lip or ridge can be provided on the interior of the cup, with the liner being snap fit between the ridge and the cup bottom for secure retention and sealing.

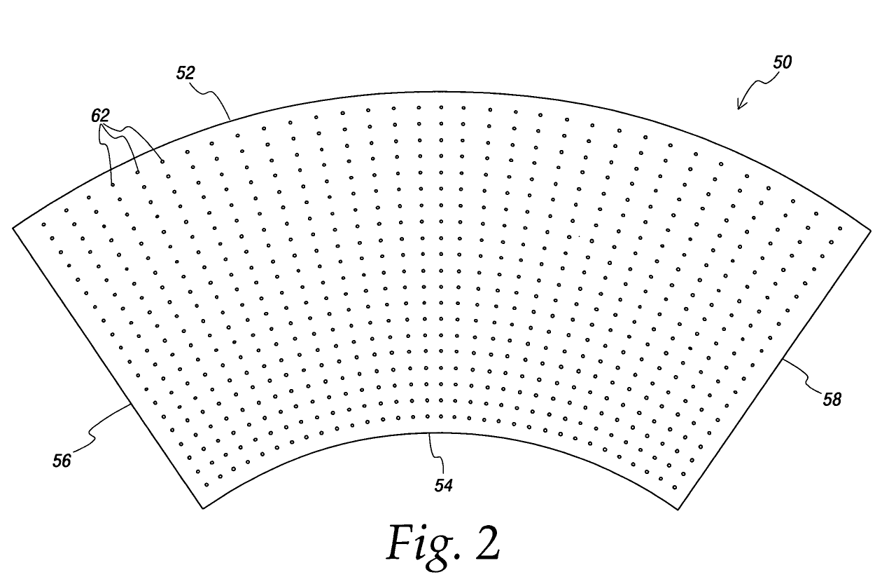

As indicated in FIG. 1, although side walls 22, 16 of both the liner 20 and cup 12 are frustoconical in shape, their angle of taper or slant is different. For example, the included angle between liner side wall 22 and the horizontal plane containing bottom wall 14 is made slightly greater than the. included angle of cup 12 formed between its frustoconical side wall 16 and a horizontal plane. As a result, a frustoconical cavity 40 is defined between liner 20 and cup 12 as indicated in FIG. 1. Frustoconical cavity 40 has a continuously changing width from top to bottom with a maximum width at the bottom of container system 10. Cavity 40 is either totally-or partially filled with a second component 42, e.g., a coffee ingredient such as ground coffee beans, tea ingredients such as herbs, and the like, tea leaves, soup bouillon, other food item or a non-food item, which is preferably in a powder, crystal, cake, jelly or other form, of predetermined minimum size (i.e., so as to be filterable) for example. Liner 20 is preferably foraminous or has a foraminous component so as to allow fluid flow communication between cavity 40 and the interior of liner 20. Preferably, liner 20 is made from a single layer of sheet material such as paper, paper board, paper products, coated paper, or plastic. The sheet material can be either perforate or imperforate. If made of imperforate material, a blank, such as blanks 52 and 82, is preferably formed from a sheet of the material and is then mechanically or otherwise perforated with a series of openings so as to render the liner foraminous, as indicated in FIGS. 2 and 4, for example. Alternatively, a portion of the blank of the imperforate material can be removed and overlaid with a sheet of perforate or otherwise foraminous material.

Liner 20 can be formed by molding a suitable material of paper, paper board, paper products, coated paper, or plastic, for example. Again, if the material is imperforate, a blank formed from a sheet of the material is mechanically or otherwise perforated, or a “window” portion is removed and replaced with material which is perforate or otherwise foraminous. For example, the “window” can be replaced by perforated imperforate material, or a molded portion of perforate or otherwise foraminous material such as foam or spun plastic, for example. Liner 20 can be formed either with or without a manufacturer's joint as is known in the art. It is generally preferred, in one instance, that the size of the perforations or foraminous passageways allowing communication through the liner be sized slightly smaller than the size of any granules, particles, or other components stored in cavity 40 which are undesirable for consumption or other use, along with the food or non-food items prepared in system 10. For example, if the item to be prepared is “natural” coffee, made from coffee beans, the coffee beans are preferably ground to a size no smaller than a prescribed minimum size. The perforations or foraminous passageways through liner 20 are then sized slightly smaller than the minimum size so as to “trap” or block passage of the coffee grounds through liner 20.

Referring now to FIG. 2, a blank 50 provides convenient economical construction of liner 20. Blank 50 has top and bottom arcuate edges 52, 54, respectively, and opposed ends 56, 58. Preferably, ends 56 and 58 are straight line in configuration so as to allow for convenient overlapping to form a manufacturers joint when blank 50 is rolled into a frusticonal shape. If desired, ends 56, 58 can be butt-joined or joined with a strip of seam material. In the preferred embodiment, blank 50 is formed from a sheet of imperforate or relatively imperforate material such as paper or coated paper, for example. Blank 50 is mechanically perforated to form plural arrays of perforations or holes 62.

In the embodiment illustrated in FIG. 2, perforations 62 are arranged in a plurality of radially-extended rows which “fan out” across the liner blank. Blank 50 is dimensioned so as to fit within a rectangular space measuring approximately 9½″×4 ¾″. The perforations 62 lie along radial lines or columns with 20 perforations or rows per column. In blank 50, thirty-three columns of perforations are used to provide blank 50 with 660 perforations. In a preferred embodiment, each perforation is of uniform size of approximately 0.0156″. The perforations are formed by piercing a sheet of polyethylene-coated paper of conventional food grade construction. Upon rolling, blank 50 takes on a conventional frustoconical shape, such as that shown in FIG. 1.

Referring now to FIG. 3, a preparation system is generally indicated at 70. In the preferred embodiment illustrated in FIG. 3, system 70 is provided with the same cup 12 as described above with reference to FIG. 1. Liner 72 is generally similar to liner 20 described above with reference to FIG. 1, except that a bottom end portion 78 of liner side wall 74 is spaced above bottom wall 14 of cup 12. The bottom end portion 78 of liner 72 is closed off to prevent component 43, loaded in cavity 76, from entering the interior of the cup defined by the liner. Cavity 76 of system 70 continuously surrounds both the sides (or at least a portion of the sides) and the bottom of liner 72. This arrangement conveniently provides an enlarged cavity volume as may be required for a particular preparation. For example, food components or non-food materials which have a lower yield per unit volume, require a greater cavity space for a given portion size of given concentration. Bottom walls of the liner and cup can be spaced as required for a particular beverage component to increase cavity volume, although this will increase the overall height of the system.

Referring now to FIG. 4, liner 72 is preferably formed from a blank 82 which generally resembles blank 50 described above with reference to FIG. 2, and has top and bottom arcuate edges 81, 83 respectively, and opposed ends 85 and 87. Blank 82 differs from blank 50 in that an extra portion 78 of blank material is provided for a bottom wall portion to be formed from a common unitary blank, along with liner side wall 74. Blank 82 is preferably formed by perforating a portion of generally imperforate sheet material so as to provide random perforations or holes 89. In the preferred embodiment illustrated in FIG. 4, that portion of blank 82 which ultimately becomes bottom wall portion 78 is not perforated although, in some applications, it may be desirable to provide bottom wall portion 78 with perforations or with a “window” of foraminous material as well.

Portion 78 of blank 82 can also be sized to provide an upturned lip for overlapping joinder with the bottom edge 83 of blank 82. Such a lip, indicated at 86 and joined to liner side wall 74, may be either internal or external to liner side wall 74 as indicated in FIGS. 5 and 6, respectively. Lip 86 may be joined to side wall 74 by virtually any technique known today including the use of adhesives, heat sealing, and ultrasonic welding, for example.

Alternatively, portion 78 of blank 82 can be replaced by a separate piece that is provided with an upturned lip such as 86 and secured to a blank such as blank 52.

Embodiments have been described above with the cup and liner having a generally frustoconical shape. If desired, one or both of the cup and liner can be formed to have a conical shape that is, having a bottom end terminating in a point. By having both cup and liner made of a conical shape, manufacturing costs can be further reduced as may be important in certain applications. That is, if the conical cup and liner are made from sheet materials, only a single manufacturer's joint is required for each of the cup and liner. Similar economies can be enjoyed. when either the cup or liner or both are made of a molded material.

If one of the cup and liner is made frustoconical and the other conical in shape, cavities having significantly enlarged volumes can be provided in a preparation system which is aesthetic as well as functional. For example, a conical liner disposed within a frustoconical cup would be made to have the. same general appearance as a conventional frustoconical coffee cup, and yet provide a substantially enlarged volume for the material component stored in the cavity between the liner and the cup.

Although preparation systems of conical or frustoconical configuration have been mentioned above, other configurations are possible. For example, cups with generally round or ovoid configurations are possible, with upper rim of the cup conforming to a user's face. Such configurations are advantageous for inhalation therapy, for example.

In use, a consumer may purchase a quantity of food preparation systems, each pre-charged with a predetermined amount of beverage component or other food material. For example, if the beverage component or food material is either coffee grounds, tea ingredients, tea leaves, or soup bouillon, for example, a user need only add heated water to conveniently prepare a predefined serving size of beverage of predetermined concentration, in a single piece disposable system assembly.

The present invention also contemplates other commercial uses of the preparation system for non-food items. For example, pre-measured chemical components, such as analytical reagents or indicators, can be conveniently provided in the cavity, in place of the beverage component or food material. A second, liquid chemical component can then be added to the cup on demand, to provide a chemical composition. If desired, the inner surface of the liner can be marked with graduations for convenient preparation of different concentrations of chemical compositions, as may be desired. When use of the chemical composition is completed, the preparation system can be disposed of, according to accepted safety practices, without requiring further handling of the system or its components.

Still other applications outside of the food industry are possible with preparation systems according to the present invention. For example, field testing of ground water, process liquids or other liquid materials can be provided to field personnel, including personnel having minimal training, to conduct color change tests other chemical field tests. In the healthcare field, testing previously carried out in a laboratory environment can now be carried out in a doctor's office or at home, for example. Solid, gelatinous or very viscous materials can be pre-loaded in preparation systems according to principles of the present invention. An overwrap of plastic, for example, can be applied to each preparation system unit for individual use on demand. Such systems could be beneficial for diabetic and other types of urinalysis.

The present invention can also benefit healthcare which requires human or animal consumption of medications and other treatments. For example, cold and flu medications can be dispensed in preparation systems according to the present invention, and individually packaged under sterile conditions for subsequent use. The preparation systems can be dispensed in single units of pre-dosed contents, as required. If desired, large numbers of preparation systems can be quickly manufactured when required to treat masses of people suffering from naturally occurring viruses, as well as biological weapons.

The simple and inexpensive materials used for the construction of the preparation systems readily lend themselves to color printing or other graphical indication clearly identifying the concentrations or different qualities of the materials dispensed in the preparation systems. By providing graduations in either the liner or cup or both, accurate concentrations of solutions may be prepared on demand, based upon a known quantity of material disposed in the cavity of the preparation system.

Although it is generally preferred that the preparation system be used by introducing liquid into the liner, other uses are possible. For example, material can be pre-dispensed in the cavity of the preparation system, and packaged in an airtight manner using known techniques. A preparation container can be fitted, molded or otherwise formed to function as a mask covering a patient's nose or mouth, for example. Upon exposure to ambient air or oxygen, or upon contacting a liquid, material disposed within the preparation system can undergo vaporization or sublimation at a controlled rate, ready for ingestion or inhalation by a patient. Likewise, a gaseous medicament can be released upon contact with water or other compatible liquid. If desired, various ports and nipples can be added to the preparation system for connection to hoses and other systems external to the preparation system.

As described above, the cavity formed between the liner and cup is generally continuous throughout. If desired, the cavity can be provided with internal walls to provide plural compartments for separating a plurality of materials disposed within the cavity and made ready for combination with a liquid or other solvent or carrier material. For example, multiple components can be dispensed within the preparation system, each component situated in an individual compartment and separated from the other compartments. Upon addition of heated water or other solvent, the components will freely mix, forming a desired product.

Although a completed assembly has been described above, the present invention also encompasses preparation systems used by food and drug manufacturers, for example, for subsequent loading of material to be trapped between the cup and liner. The same cup and liner components can be used with a wide variety of food, drug, chemical testing or other materials to be dispensed in measured quantities, in conjunction with joining the liner and cup components together. The completed assembly can then be sterilized or otherwise treated as necessary and individually packaged for subsequent use.

The foregoing description and the accompanying drawings are illustrative of the present invention. Still other variations in arrangements of parts are possible without departing from the spirit and scope of this invention.

I claim:

1. A preparation system, comprising:
a cup for holding a first component, the cup having a cup side wall with an inner surface;
a liner disposed within the cup, the liner having a liner side wall;
at least a portion of the liner side wall being spaced from the inner surface of the cup side wall, to define a cavity for receiving at least one other component; and
at least a portion of the liner being foraminous so as to allow fluid flow communication between the first component and the at least one other component while retaining at least a portion of the at least one other component in the cavity during preparation and use of a product resulting from combination of the first and the at least one other component.

2. The system of claim 1 wherein the cup and the liner are in sealing engagement with one another at said inner surface.

3. The system of claim 1 wherein the at least one other component contains a coffee ingredient.

4. The system of claim 3 wherein the coffee ingredient is ground coffee beans.

5. The system of claim 1 wherein the at least one other component contains a tea ingredient.

6. The system of claim 5 wherein the tea ingredient is tea leaves.

7. The system of claim 1 wherein the cup has a generally frustoconical shape.

8. The system of claim 1 wherein the cup has a generally conical shape.

9. The system of claim 1 wherein the liner has a generally frustoconical shape.

10. The system of claim 1 wherein the liner has a generally conical shape.

11. The system of claim 1 wherein the liner is made of generally imperforate material which is perforated.

12. A system for preparing a solution from multiple components, comprising:
a cup for holding a first component, the cup having a side wall with an inner surface;
a liner secured within the cup, the liner having a side wall, with at least a portion of the liner sidewall being spaced from the inner surface of the cup side wall, to define a cavity for receiving at least one second component; and
at least a portion of the liner being foraminous so as to allow fluid flow communication between the first component and the at least one second component, while retaining at least a portion of the at least one second component in the cavity during preparation of a solution made from the first component and the at least one second component.

13. The system of claim 12 wherein the cup and the liner are in sealing engagement with one another to retain at least a portion of the at least one second component in the cavity.

14. The system of claim 12 further comprising a seal cooperating with the cup and the liner to retain at least a portion of the at least one second component in the cavity.

15. The system of claim 12 wherein the first component is a liquid and the cup is liquid-tight.

16. The system of claim 12 wherein the at least one second component is a solid and the cup and the liner cooperate to retain the solid in place during preparation of the solution.

17. The system of claim 12 wherein the at least one second component is a substantially non-flowing material and the cup and the liner cooperate to retain the substantially-non-flowing material in place during preparation of the solution.

18. The system of claim 12 wherein the cup is made of a paper material.

19. The system of claim 12 wherein the cup is made of a coated paper material.

20. The system of claim 12 wherein the cup is made of a plastic material.

21. The system of claim 12 wherein the cup is made of a composite material.

22. The system of claim 12 wherein the liner is made of paper material.

23. The system of claim 12 wherein the liner is made of a coated paper material.

24. The system of claim 12 wherein the liner is made of plastic material.

25. The system of claim 12 wherein the liner is made of a composite material.

26. A preparation system, comprising:
a cup for holding a first component, the cup having a sidewall with an inner surface;
a liner disposed within the cup, at least a portion of the liner being spaced from the inner surface of the cup, to create a cavity;
at least one other component disposed in the cavity; and
at least a portion of the liner being foraminous so as to allow communication between the first component and the at least one other component while retaining the at least one other component in the cavity during preparation and use of a product made by combining the first and the at least one other component.

27. The system of claim 26 further comprising an overwrap of film material over wrapping the cup and the liner.

28. The system of claim 26 wherein the cup and the liner are secured to one another to retain the at least one other component in the cavity.
